(19) United States
(12) Patent Application Publication
(10) Pub. No.: US 2026/0059525 A1
(43) Pub. Date: Feb. 26, 2026

(54) SYSTEM AND METHOD FOR FRAME PROTECTION IN WIRELESS COMMUNICATIONS

(71) Applicant: NXP USA, Inc., AUSTIN, TX (US)

(72) Inventors: Liwen Chu, San Ramon, CA (US); Huizhao Wang, San Jose, CA (US); Ken Kinwah Ho, San Jose, CA (US); Kiseon Ryu, San Diego, CA (US); Hongyuan Zhang, Fremont, CA (US)

(21) Appl. No.: 19/307,759

(22) Filed: Aug. 22, 2025

Related U.S. Application Data
(60) Provisional application No. 63/685,850, filed on Aug. 22, 2024.

(51) Int. Cl. H04W 72/20

(52) U.S. Cl. CPC H04W 72/20

(57) ABSTRACT

Embodiments of a method and apparatus for wireless communications are disclosed. In an embodiment, a wireless device includes a controller configured to generate a protected frame using a key for integrity checking or encryption or decryption protection, where a packet number (PN) space of the key is divided to independent PN subspaces for control frame protection and data and management frame protection, and a transceiver configured to transmit the protected frame to a second wireless device.

### CROSS-REFERENCE TO RELATED APPLICATIONS

This application is entitled to the benefit of U.S. Provisional Patent Application Ser. No. 63/685,850, filed on Aug. 22, 2024, the contents of which are incorporated by reference herein in their entireties.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. To facilitate the proper data transmission within a wireless communications system, there is a need for wireless communications technology that can efficiently and securely convey communications signaling information, for example, information related to data, communications links, and/or wireless devices (e.g., operation and/or capability parameters of wireless devices) within the wireless communications system.

### SUMMARY

Embodiments of a method and apparatus for wireless communications are disclosed. In an embodiment, a wireless device includes a controller configured to generate a protected frame using a key for integrity checking or encryption or decryption protection, where a packet number (PN) space of the key is divided to independent PN subspaces for control frame protection and data and management frame protection, and a transceiver configured to transmit the protected frame to a second wireless device. Other embodiments are also disclosed.

In an embodiment, the key includes a peer transient key (PTK), and a PN space of the PTK is divided to independent PN subspaces for unicast control frame protection and for unicast data and management frame protection.

In an embodiment, the PN space of the PTK is divided to a first PN subspace containing n with n being a positive integer that is no more than 24-1 or zero for unicast control frame protection and a second PN subspace containing n+m*2⁴⁴ with m being one of integers from 1 to 15 for unicast data and management frame protection.

In an embodiment, the PN space of the PTK is divided to a first PN subspace containing n*16 for unicast control frame protection and a second PN subspace containing n*16+m for unicast data and management frame protection, m is one of integers from 1 to 15, and n is a positive integer that is no more than 2⁴⁴−1 or zero.

In an embodiment, the protected frame includes a unicast frame, and the unicast frame is integrity checked or decrypted by the second wireless device.

In an embodiment, the key includes a group temporal key (GTK), and wherein a PN space of the GTK is divided to independent PN subspaces for multicast or broadcast control frame protection and multicast or broadcast data and management frame protection.

In an embodiment, the PN space of the GTK is divided to a first PN subspace for multicast or broadcast control frame protection and a second PN subspace for multicast or broadcast data and management frame protection.

In an embodiment, the PN space of the GTK is divided to a first PN subspace containing n*16 for multicast or broadcast control frame protection and a second PN subspace containing n*16+m for multicast or broadcast data and management frame protection, m is one of integers from 1 to 15, and n is a positive integer that is no more than 2⁴⁴−1 or zero.

In an embodiment, the protected frame includes a multicast or broadcast frame, and the multicast or broadcast frame is integrity checked or decrypted by the second wireless device.

In an embodiment, the protected frame includes a protected control frame, and additional authentication data (AAD) of the protected control frame includes frame duration (FC) information, transmitter address (TA) information, and duration information.

In an embodiment, the wireless device includes a wireless access point (AP) or a non-AP station (STA).

In an embodiment, the wireless device is compatible with an Institute of Electrical and Electronics Engineers (IEEE) 802.11 protocol.

In an embodiment, the wireless device includes a wireless multi-link device (MLD), the second wireless device includes a second wireless MLD, and the transceiver includes a wireless transceiver configured to transmit the protected frame to the second wireless MLD through a wireless link between the wireless MLD and the second wireless MLD.

In an embodiment, a wireless multi-link device (MLD) includes a controller configured to generate a protected frame using a key for integrity checking or encryption or decryption protection, where a packet number (PN) space of the key is divided to independent PN subspaces for control frame protection and data and management frame protection, and a wireless transceiver configured to transmit the protected frame to a second wireless MLD through a wireless link between the wireless MLD and the second wireless MLD, and where the protected frame is integrity checked or decrypted by the second wireless MLD.

In an embodiment, a method for wireless communications involves at a first wireless device, generating a protected frame using a key for integrity checking or encryption or decryption protection, where a packet number (PN) space of the key is divided to independent PN subspaces for control frame protection and data and management frame protection, and from the first wireless device, transmitting the protected frame to a second wireless device.

In an embodiment, the key includes a peer transient key (PTK), and a PN space of the PTK is divided to independent PN subspaces for unicast control frame protection and unicast data and management frame protection.

In an embodiment, the PN space of the PTK is divided to a first PN subspace containing n*16 for unicast control frame protection and a second PN subspace containing n*16+m for unicast data and management frame protection, m is one of integers from 1 to 15, and n is a positive integer that is no more than 2⁴⁴−1 or zero.

In an embodiment, the key includes a group temporal key (GTK), and a PN space of the GTK is divided to independent PN subspaces for multicast or broadcast control frame protection and multicast or broadcast data and management frame protection.

In an embodiment, the PN space of the GTK is divided to a first PN subspace containing n*16 for multicast or broadcast control frame protection and a second PN subspace containing n*16+m for multicast or broadcast data and management frame protection, m is one of integers from 1 to 15, and n is a positive integer that is no more than 2⁴⁴−1 or zero.

In an embodiment, the protected frame includes a multicast or broadcast frame, and the multicast or broadcast frame is integrity checked or decrypted by the second wireless device.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link (ML) communications system that is used for wireless communications in accordance with an embodiment of the invention.

FIG. 3 depicts a wireless device in accordance with an embodiment of the invention.

FIG. 4 illustrates a protected frame format in accordance with an embodiment of the invention.

FIG. 5 depicts a PN space that are divided into two PN subspaces in accordance with an embodiment of the invention.

FIG. 6 depicts a PN space that are divided into two PN subspaces in accordance with an embodiment of the invention.

FIG. 7 depicts additional authentication data (AAD) in accordance with an embodiment of the invention.

FIG. 8 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

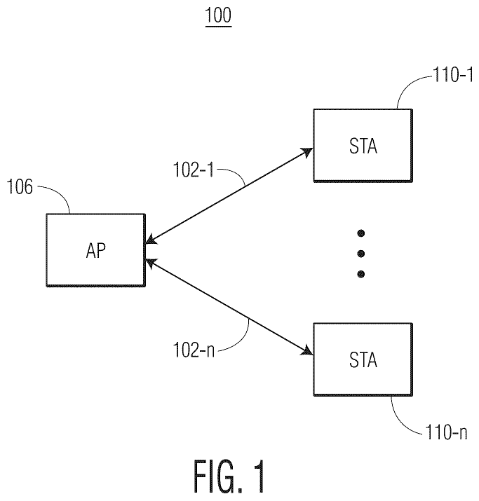

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or an Institute of Electrical and Electronics Engineer (IEEE) 802.11 communication protocol (e.g., an IEEE 802.11bn communication protocol). In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

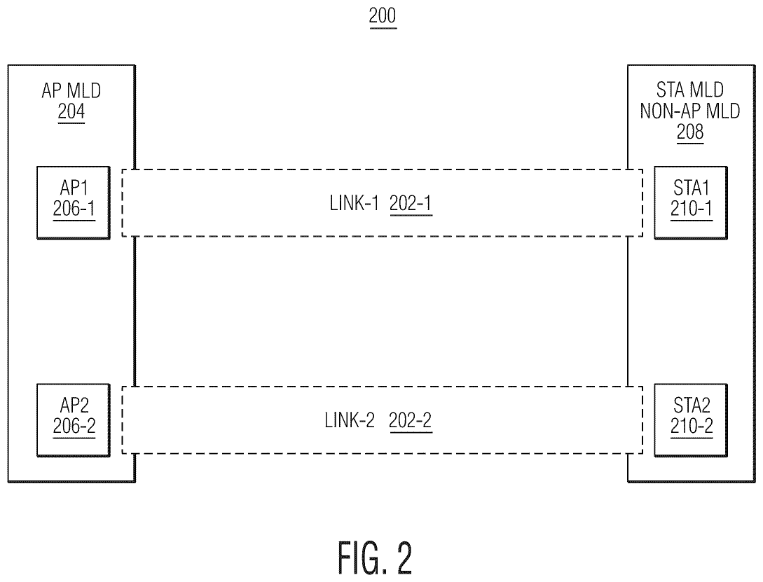

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., beaconing, association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re)Association Request frame, a (Re)Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1 202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

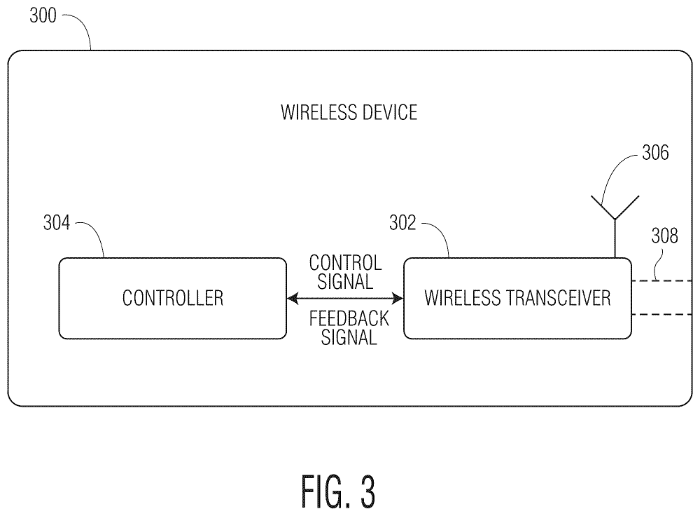

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In accordance with an embodiment of the invention, the controller 304 is configured to generate a protected frame using a key for integrity checking and/or encryption or decryption protection, where a packet number (PN) space of the key is divided to independent PN subspaces for control frame protection and for data and management frame protection, and the wireless transceiver 302 is configured to transmit the protected frame to a second wireless device, for example, wirelessly transmit the protected frame to the second wireless device through the at least one antenna 306. In some embodiments, the protected frame is a frame that is encrypted to prevent unauthorized access and attacks. The protected frame can be integrity checked or decrypted to ensure its authenticity and integrity. In some embodiments, the key includes a peer transient key (PTK), and a PN space of the PTK is divided to independent PN subspaces for unicast control frame protection and for unicast data/Management frame protection, for example, by the controller 304. In some embodiments, the PN space of the PTK is divided to a first PN subspace for unicast control frame protection and a second PN subspace for unicast data/Management frame protection, for example, by the controller 304. In some embodiments, the PN space of the PTK is divided to a first PN subspace containing n*16 for unicast control frame protection and a second PN subspace containing n*16+m for unicast data/Management frame protection with m is one of the integers from 1 to 15, for example, by the controller 304, n is a positive integer that is no more than 2⁴⁴−1 or zero. In some embodiments, the PN space of the PTK is divided to a first PN subspace containing n with n being a positive integer that is no more than 2⁴⁴−1 or zero for unicast control frame protection and a second PN subspace containing n+m*2⁴⁴ for unicast data/Management frame protection with m is one of the integers from 1 to 15. In some embodiments, the protected frame includes a unicast frame, and the unicast frame is integrity checked or decrypted by the second wireless device. In some embodiments, the key includes a group temporal key (GTK), and a PN space of the GTK is divided to independent PN subspaces for multicast or broadcast control frame protection and multicast or broadcast data/Management frame protection, for example, by the controller 304. In some embodiments, the PN space of the GTK is divided to a first PN subspace for multicast or broadcast control frame protection and a second PN subspace for multicast or broadcast data frame protection. In some embodiments, the PN space of the GTK is divided to a first PN subspace containing n*16 for multicast or broadcast control frame protection and a second PN subspace containing n*16+m for multicast or broadcast data and management frame protection with m is one of the integers from 1 to 15, for example, by the controller 304, n is a positive integer that is no more than 2⁴⁴−1 or zero. In some embodiments, the protected frame includes a multicast or broadcast frame, and the multicast or broadcast frame is integrity checked by the second wireless device. In some embodiments, the protected frame includes a protected control frame, and additional authentication data (AAD) of the protected control frame includes frame duration (FC) information, transmitter address (TA) information, and duration information. In some embodiments, the wireless device includes a wireless access point (AP) or a wireless non-AP station (STA). In some embodiments, the wireless device is compatible with an Institute of Electrical and Electronics Engineers (IEEE) 802.11 protocol. In some embodiments, the wireless device 300 includes a wireless multi-link device (MLD), the second wireless device comprises a second wireless MLD, and the wireless transceiver is further configured to transmit the frame to the second wireless MLD through a wireless link between the wireless MLD and the second wireless MLD. In some embodiments, a wireless multi-link device (MLD) includes a controller configured to generate a protected frame using a key for integrity checking or encryption or decryption protection, where a packet number (PN) space of the key is divided to independent PN subspaces for control frame protection, and data and management frame protection, and a wireless transceiver configured to transmit the protected frame to a second wireless MLD through a wireless link between the wireless MLD and the second wireless MLD, and wherein the protected frame is integrity checked or decrypted by the second wireless MLD.

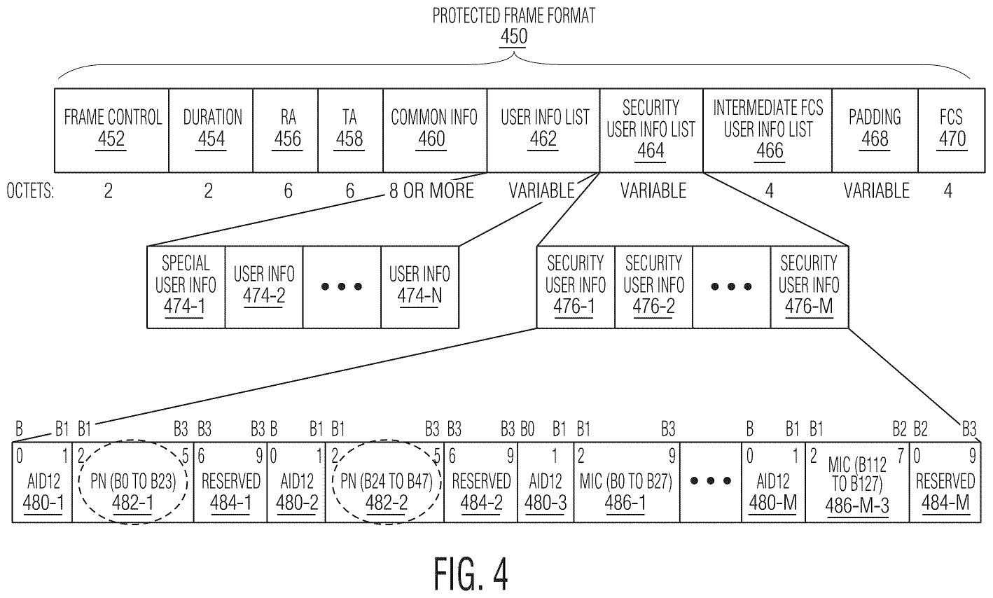

FIG. 4 illustrates a protected frame format 450 in accordance with an embodiment of the invention. The protected frame format 450 (e.g., a protected trigger frame format) illustrated in FIG. 4 can be used for communications by the wireless communications system 100 depicted in FIG. 1, by a STA/AP affiliated with the multi-link (ML) communications system 200 depicted in FIG. 2, and/or the wireless device 300 depicted in FIG. 3. In some embodiments, the protected frame is a frame that is encrypted to prevent unauthorized access and attacks. The protected frame can be integrity checked or decrypted to ensure its authenticity and integrity. In the embodiment depicted in FIG. 4, the protected frame format 450 includes a frame control field 452 (e.g., two-octet) that may contain frame control information (e.g., protected frame field indicates whether the control frame is protected or not), a frame duration field 454 (e.g., two-octet) that may contain frame duration information, a receiver address (RA) field 456 (e.g., six-octet) that may contain receiver address information, a transmitter address (TA) field 458 (e.g., six-octet) that may contain transmitter address information, a common information (info) field 460 (e.g., eight-octet or more) that may contain common information, a user information list field 462 (e.g., variable length) that may contain user information list information, a security user information list field 464 (e.g., variable length) that may contain security user information list, a padding field 468 (e.g., variable length) that may contain padding information, and a frame check sequence (FCS) field 470 (e.g., four-octet) that may contain FCS information. In some embodiments, the user information list field 462 may include multiple user info fields 474-1, . . . , 474-N, where N is a positive integer, with the first User Info field 474-1 being the Special User Info field that can be used to carry PHY version, additional bandwidth (BW) information of the solicited trigger based (TB) PPDU, etc., In some embodiments, the security user information list field 464 may include multiple security user info fields 476-1, . . . , 476-M, where M is a positive integer. In some embodiments, the security user info fields 476-1, . . . , 476-M includes Association ID (AID) AID12 fields 480-1, . . . , 480-M, for carrying AID information with a value more than 2007, e.g. 2009, packet number (PN) fields 482-1, 482-2, for carrying PN information, reserved (Rsvd) fields 484-1, . . . , 484-M for carrying reserved information, and message integrity check (MIC) fields 486-1, . . . , 486-M for carrying MIC information.

In some implementations, peer transient key (PTK) is used for control frame protection while the key for broadcast control frame protection and the key for protecting broadcast Data/Management frames are different. In some implementations, peer transient key (PTK) is used for control frame protection and beacon integrity group temporal key (BIGTK) (group temporal key (GTK) or Integrity Group Temporal Key (IGTK)) is used for broadcast frame protection. With such key arrangement, the PN spaces of PTK and of BIGTK need to be carefully designed.

In some embodiments, the PN space of the PK in a PTK is divided to independent PN subspaces with separate PN subspaces for unicast control frame protection and unicast data and management frame protection (e.g., by the controller 304).

In some embodiments, the PN space of a GTK (BIGTK or IGTK) is divided to independent PN subspaces with the separate PN subspaces for broadcast control frame protection and broadcast data frame protection (e.g., beacon frame protection or broadcast management frame protection) (e.g., by the controller 304).

Some implementations of the PN Space of the TK in a PTK, for example, by the wireless communications system 100 depicted in FIG. 1, the multi-link (ML) communications system 200 depicted in FIG. 2, and/or the wireless device 300 depicted in FIG. 3 are described.

In some embodiments, by using PN subspaces of the TK in a PTK, the TK in PTK can be used for the protection of unicast control frames and the encryption/decryption of unicast Data/Management frames (e.g., by the controller 304).

In some embodiments, the PN space of the TK in a PTK is divided to multiple PN subspaces, e.g., 2 PN subspaces n*2+i with integer i being one of 0 and 1 and n being an integer or zero from 0 to 2⁴⁷−1, 2 PN subspaces n*16+15 and n*16+i with integer i being one of [0, 14] where n is an integer from 0 to 2⁴⁴−1, or 16 PN subspaces n*16+i with integer i being one of [0, 15] and n being an integer from 0 to 2⁴⁴−1.

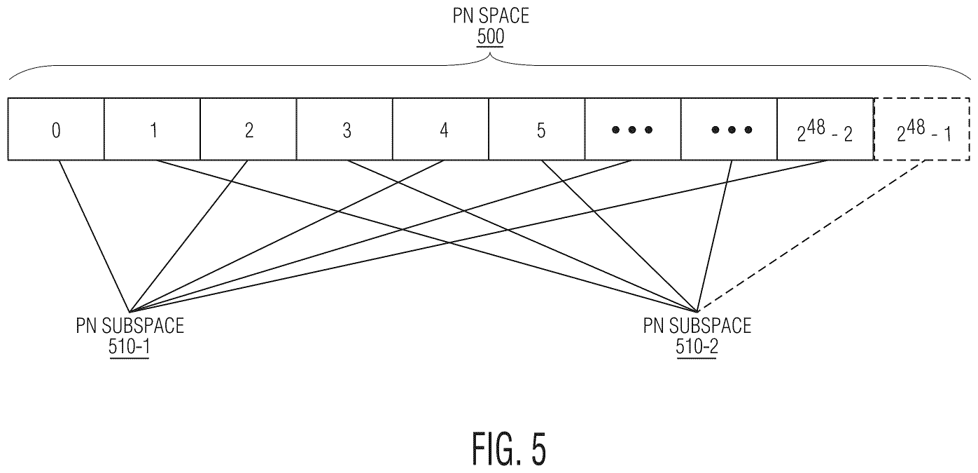

FIG. 5 depicts a PN space 500 that are divided into two PN subspaces 510-1, 510-2 in accordance with an embodiment of the invention. The PN space 500 and the PN subspaces 510-1, 510-2 depicted in FIG. 5 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 5, the PN space 500 has a sequence of 0, 1, 2, 3, 4, 5 . . . , 2⁴⁸−1 and is divided into the following two PN subspaces:
0, 2, 4, 6, 8, 10, 12, . . . 2⁴⁸−2→PN subspace 1 510-1;
1, 3, 5, 7, 9, 11, 13, . . . , 2⁴⁸−1→PN subspace 2 510-2.
   In some embodiments, the PN subspace 510-1 is used for unicast control frame protection (e.g., by the controller 304) and the second PN subspace 510-2 is used for unicast data and management frame protection (e.g., by the controller 304).

In some embodiments, one PN subspace, e.g., n+15*2⁴⁴ with n being an integer from 0 to 2⁴⁴−1 is allocated for unicast control frame protection, while another PN subspace, e.g., n+m*2⁴⁴ with m being an integer from 0 to 14 is allocated for unicast Data and management frame protection. In some embodiments, one PN subspace, e.g., n with n being an integer from 0 to 2⁴⁴−1 is allocated for unicast control frame protection, while another PN subspace, e.g., n+m*2⁴⁴ with m being an integer from 1 to 15 is allocated for unicast Data and management frame protection.

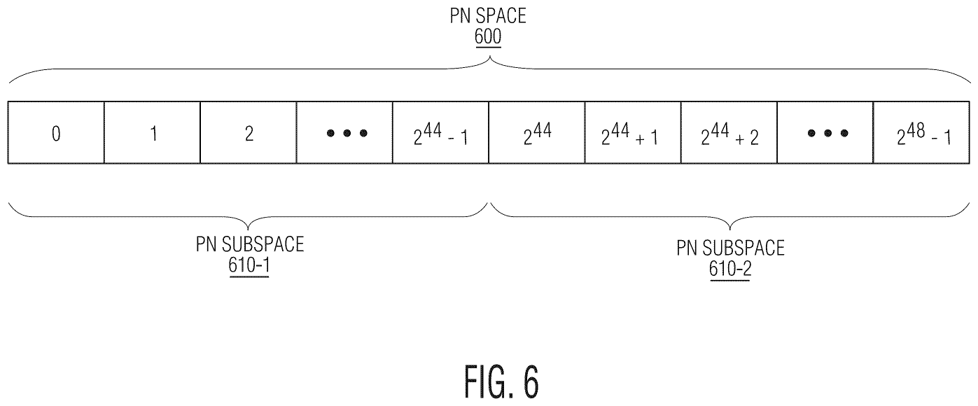

FIG. 6 depicts a PN space 600 that are divided into two PN subspaces 610-1, 610-2 in accordance with an embodiment of the invention. The PN space 600 and the PN subspaces 610-1, 610-2 depicted in FIG. 6 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 6, the PN space 600 has a sequence of 0, 1, 2, 3, 4, 5 . . . , 2⁴⁸−1 and is divided into the following two PN subspaces:
0, 1, 2, 3, 4, 5, . . . , 2⁴⁴−1→PN subspace 1 610-1;
2⁴⁴, 2⁴⁴+1, 2⁴⁴+2, 2⁴⁴+3, 2⁴⁴+4, 2⁴⁴+5, 2⁴⁴+6, . . . , 2⁴⁸−1→PN subspace 2 610-2. In some embodiments, the PN subspace 610-1 is used for unicast control frame protection (e.g., by the controller 304) and the second PN subspace 610-2 is used for unicast data and management frame protection (e.g., by the controller 304).

Some implementations of PN Space of GTK, for example, by the wireless communications system 100 depicted in FIG. 1, the multi-link (ML) communications system 200 depicted in FIG. 2, and/or the wireless device 300 depicted in FIG. 3 are described.

In some embodiments, the PN space of a GTK is divided to multiple PN subspaces, e.g., 2 PN subspaces n*2+i with integer i being one of 0 and 1 and n being an integer from 0 to 2⁴⁷−1.

In some embodiments, one PN subspace, e.g., n*16+15 with n being an integer of [0, 2⁴⁴−1] is allocated for broadcast control frame protection, while another PN space, e.g., n*16+m with m being an integer of [0, 14] and n being an integer of [0, 2⁴⁴−1] is allocated for broadcast data frame protection. In some embodiments, one PN subspace, e.g., n with n being an integer of [0, 2⁴⁴−1] is allocated for broadcast control frame protection, while another PN space, e.g., n*16+m with m being an integer of [1, 15] is allocated for broadcast data frame protection.

A protected broadcast control frame, e.g., a protected Trigger frame may need to carry an intermediate frame check sequence (FCS). In some embodiments, a protected frame is a frame that is encrypted to prevent unauthorized access and attacks. A protected frame can be integrity checked or decrypted to ensure its authenticity and integrity. With the intermediate FCS, the recipient of the protected control frame can skip the decode of the padding part of the protected control frame. In some embodiments, one optimization is to replace intermediate FCS by MIC.

Some implementations of MIC Calculation, for example, by the wireless communications system 100 depicted in FIG. 1, the multi-link (ML) communications system 200 depicted in FIG. 2, and/or the wireless device 300 depicted in FIG. 3 are described.

In some embodiments, all the fields of MAC header of a control frame being protected are protected by the MIC of the frame.

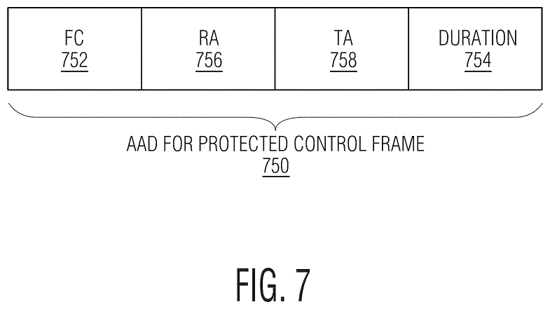

FIG. 7 depicts additional authentication data (AAD) 750 in accordance with an embodiment of the invention. The AAD 750 depicted in FIG. 7 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 7, the AAD 750 of a protected control frame includes frame duration (FC) information 752, receiver address (RA) information 754, transmitter address (TA) information 756, and duration information 758.

In some embodiments, in one variant, the AAD of a broadcast protected control frame includes FC, TA, and Duration.

In some embodiments, the RA is not covered since it is always equal to all 1s.

Some implementations of No Intermediate FCS in Protected Control Frame, for example, by the wireless communications system 100 depicted in FIG. 1, the multi-link (ML) communications system 200 depicted in FIG. 2, and/or the wireless device 300 depicted in FIG. 3 are described.

In some embodiments, in a protected unicast control frame whose recipient needs to stop the decoding of the frame's FCS field, the intermediate FCS is not carried in the protected frame.

In some embodiments, if all the recipients of a protected broadcast control frame that need to stop the decoding of the frame's FCS field support the control frame protection, the intermediate FCS is not carried in the protected frame.

In some embodiments, in a method of improving the security for the frame exchanges between a first device and a second device, an individual-addressed (=unicast) Control frame is protected by a PTK with the PN being different from the PN for a unicast Data/Management frame, a group-addressed (=broadcast/multicast) Control frame is protected by a GTK with the PN being different from the PN for a broadcast Data frame. In some embodiments, the PN space of a PTK is divided to two PN subspaces, for example, n*16+15 and n*16+i with i being one of the integers from 0 to 14 and n being a positive integer from 0 to 2⁴⁴−1. In some embodiments, the PN subspace n*16+15 is for unicast control frames while the PN subspace n*16+i with i being one of the integers from 0 to 14 is for unicast Data/Management frames. In some embodiments, the PN space of a PTK is divided to two PN subspaces, for example, n*16 and n*16+i with i being one of the integers from 1 to 15 and n being a positive integer from 0 to 2⁴⁴−1. In some embodiments, the PN subspace n*16 is for unicast control frames while the PN subspace n*16+i with i being one of the integers from 1 to 15 is for unicast Data/Management frames. In some embodiments, the PN space of a PTK is divided to two PN subspaces, for example, n with n being a positive integer from 0 to 2⁴⁴−1 and n+i*2⁴⁴ with i being one of the integers from 1 to 15. In some embodiments, the PN subspace n with n being a positive integer from 0 to 2⁴⁴−1 is for unicast control frames while the PN subspace n+i*2⁴⁴ with i being one of the integers from 1 to 15 for unicast Data/Management frames. In some embodiments, the PN space of a GTK is divided to multiple PN subspaces, for example, n*16+15 and n*16+i with i being one of the integers from 0 to 14 and n being a positive integer from 0 to 2⁴⁴−1. In some embodiments, the PN subspace n*16+15 is for broadcast control frames while the PN subspace n*16+i with i being one of the integers from 0 to 14 is for broadcast Data frames.

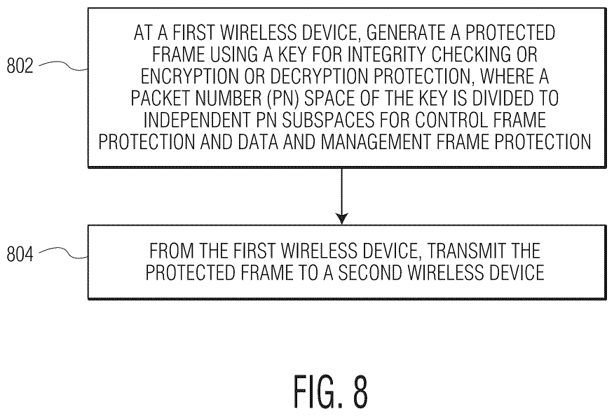

FIG. 8 is a process flow diagram of a method for wireless communications in accordance with an embodiment of the invention. At block 802, at a first wireless device, a protected frame is generated using a key for integrity checking or encryption or decryption protection, where a packet number (PN) space of the key is divided to independent PN subspaces for control frame protection and data and management frame protection. At block 804, from the first wireless device, the frame is transmitted to a second wireless device. In some embodiments, the key includes a peer transient key (PTK), and a PN space of the PTK is divided to independent PN subspaces for unicast control frame protection and unicast data and management frame protection. In some embodiments, the protected frame is a frame that is encrypted to prevent unauthorized access and attacks. The protected frame can be integrity checked or decrypted to ensure its authenticity and integrity. In some embodiments, the PN space of the PTK is divided to a first PN subspace for unicast control frame protection and a second PN subspace for unicast data and management frame protection. In some embodiments, the PN space of the PTK is divided to a first PN subspace containing n*16 for unicast control frame protection and a second PN subspace containing n*16+m for unicast data/Management frame protection, where m is one of the integers from 1 to 15, and n is a positive integer that is no more than 2⁴⁴−1 or zero. In some embodiments, the PN space of the PTK is divided to a first PN subspace containing n*16+15 for unicast control frame protection and a second PN subspace containing n*16+i with i being an integer of [0, 14] for unicast data/Management frame protection, n is a positive integer of [1, 2⁴⁴−1] or zero. In some embodiments, the protected frame includes a unicast frame, and the unicast frame is integrity checked or decrypted by the second wireless device. In some embodiments, the key includes a group temporal key (GTK), and a PN space of the GTK is divided to independent PN subspaces for multicast or broadcast control frame protection and multicast or broadcast data and management frame protection. In some embodiments, the PN space of the GTK is divided to a first PN subspace for multicast or broadcast control frame protection and a second PN subspace for multicast or broadcast data and management frame protection. In some embodiments, the PN space of the GTK is divided to a first PN subspace containing n*16 for multicast or broadcast control frame protection and a second PN subspace containing n*16+m for multicast or broadcast data and management frame protection, where m is one of the integers from 1 to 15, n is a positive integer or zero. In some embodiments, the protected frame includes a multicast or broadcast frame, and the multicast or broadcast frame is integrity checked or decrypted by the second wireless device. In some embodiments, the protected frame includes a protected control frame, and additional authentication data (AAD) of the protected control frame includes frame duration (FC) information, transmitter address (TA) information, and duration information. In some embodiments, the wireless device includes a wireless access point (AP) or a wireless non-AP station (STA). In some embodiments, the wireless device is compatible with an Institute of Electrical and Electronics Engineers (IEEE) 802.11 protocol. In some embodiments, the wireless device includes a wireless multi-link device (MLD), the second wireless device comprises a second wireless MLD, and the wireless transceiver is further configured to transmit the frame to the second wireless MLD through a wireless link between the wireless MLD and the second wireless MLD. The wireless device may be the same as or similar to an embodiment of the AP 106 depicted in FIG. 1, the APs 206-1, 206-2 depicted in FIG. 2, and/or the wireless device 300 depicted in FIG. 3.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless device comprising:
a controller configured to generate a protected frame using a key for integrity checking or encryption or decryption protection, wherein a packet number (PN) space of the key is divided to a plurality of independent PN subspaces for control frame protection and for data and management frame protection; and
a transceiver configured to transmit the protected frame to a second wireless device.

2. The wireless device of claim 1, wherein the key comprises a peer transient key (PTK), and wherein a PN space of the PTK is divided to a plurality of independent PN subspaces for unicast control frame protection and for unicast data and management frame protection.

3. The wireless device of claim 2, wherein the PN space of the PTK is divided to a first PN subspace containing n with n being a positive integer that is no more than 2⁴⁴−1 or zero for unicast control frame protection and a second PN subspace containing n+m*2⁴⁴ with m being one of integers from 1 to 15 for unicast data and management frame protection.

4. The wireless device of claim 2, wherein the PN space of the PTK is divided to a first PN subspace containing n*16 for unicast control frame protection and a second PN subspace containing n*16+m for unicast data and management frame protection, wherein m is one of integers from 1 to 15, and wherein n is a positive integer that is no more than 2⁴⁴−1 or zero.

5. The wireless device of claim 1, wherein the protected frame comprises a unicast frame, and wherein the unicast frame is integrity checked or decrypted by the second wireless device.

6. The wireless device of claim 1, wherein the key comprises a group temporal key (GTK), and wherein a PN space of the GTK is divided to a plurality of independent PN subspaces for multicast or broadcast control frame protection and multicast or broadcast data and management frame protection.

7. The wireless device of claim 6, wherein the PN space of the GTK is divided to a first PN subspace for multicast or broadcast control frame protection and a second PN subspace for multicast or broadcast data and management frame protection.

8. The wireless device of claim 6, wherein the PN space of the GTK is divided to a first PN subspace containing n*16 for multicast or broadcast control frame protection and a second PN subspace containing n*16+m for multicast or broadcast data and management frame protection, wherein m is one of integers from 1 to 15, and wherein n is a positive integer that is no more than 2⁴⁴−1 or zero.

9. The wireless device of claim 1, wherein the protected frame comprises a multicast or broadcast frame, and wherein the multicast or broadcast frame is integrity checked or decrypted by the second wireless device.

10. The wireless device of claim 1, wherein the protected frame comprises a protected control frame, and wherein additional authentication data (AAD) of the protected control frame comprises frame duration (FC) information, transmitter address (TA) information, and duration information.

11. The wireless device of claim 1, wherein the wireless device comprises a wireless access point (AP) or a non-AP station (STA).

12. The wireless device of claim 1, wherein the wireless device is compatible with an Institute of Electrical and Electronics Engineers (IEEE) 802.11 protocol.

13. The wireless device of claim 1, wherein the wireless device comprises a wireless multi-link device (MLD), wherein the second wireless device comprises a second wireless MLD, and wherein the transceiver comprises a wireless transceiver configured to transmit the protected frame to the second wireless MLD through a wireless link between the wireless MLD and the second wireless MLD.

14. A wireless multi-link device (MLD) comprising:
a controller configured to generate a protected frame using a key for integrity checking or encryption or decryption protection, wherein a packet number (PN) space of the key is divided to a plurality of independent PN subspaces for control frame protection and data and management frame protection; and
a wireless transceiver configured to transmit the protected frame to a second wireless MLD through a wireless link between the wireless MLD and the second wireless MLD, and wherein the protected frame is integrity checked or decrypted by the second wireless MLD.

15. A method for wireless communications, the method comprising:
at a first wireless device, generating a protected frame using a key for integrity checking or encryption or decryption protection, wherein a packet number (PN) space of the key is divided to a plurality of independent PN subspaces for control frame protection and data and management frame protection; and
from the first wireless device, transmitting the protected frame to a second wireless device.

16. The method of claim 15, wherein the key comprises a peer transient key (PTK), and wherein a PN space of the PTK is divided to a plurality of independent PN subspaces for unicast control frame protection and unicast data and management frame protection.

17. The method of claim 16, wherein the PN space of the PTK is divided to a first PN subspace containing n*16 for unicast control frame protection and a second PN subspace containing n*16+m for unicast data and management frame protection, wherein m is one of integers from 1 to 15, and wherein n is a positive integer that is no more than 2⁴⁴−1 or zero.

18. The method of claim 15, wherein the key comprises a group temporal key (GTK), and wherein a PN space of the GTK is divided to a plurality of independent PN subspaces for multicast or broadcast control frame protection and multicast or broadcast data and management frame protection.

19. The method of claim 18, wherein the PN space of the GTK is divided to a first PN subspace containing n*16 for multicast or broadcast control frame protection and a second PN subspace containing n*16+m for multicast or broadcast data and management frame protection, wherein m is one of integers from 1 to 15, and wherein n is a positive integer that is no more than 2⁴⁴−1 or zero.

20. The method of claim 19, wherein the protected frame comprises a multicast or broadcast frame, and wherein the multicast or broadcast frame is integrity checked or decrypted by the second wireless device.
